(19) United States
(12) Patent Application Publication
(10) Pub. No.: US 2024/0346319 A1
(43) Pub. Date: Oct. 17, 2024

(54) AI TRAINING METHOD, AI TRAINING DEVICE, AND AI TRAINING PROGRAM

(71) Applicant: DENSO TEN Limited, Kobe-shi (JP)

(72) Inventors: Yasutaka OKADA, Kobe-shi (JP); Ryusuke Seki, Kobe-shi (JP); Keisuke Yamano, Kobe-shi (JP)

(73) Assignee: DENSO TEN Limited, Kobe-shi (JP)

(21) Appl. No.: 18/601,150

(22) Filed: Mar. 11, 2024

(30) Foreign Application Priority Data
Apr. 11, 2023 (JP) 2023-064321

(51) Int. Cl. G06N 3/084

(52) U.S. Cl. CPC G06N 3/084

(57) ABSTRACT

An AI training method includes inputting training data to an existing trained AI model to acquire a trained-layer feature value output from a trained layer in the existing trained AI model, merging the trained-layer feature value with a training-target layer feature value output from a training-target layer in the training-target AI model to generate a merged feature value, and inputting the merged feature value to a training-target layer subsequent to the training-target layer to generate a new trained AI model.

### CROSS-REFERENCES TO RELATED APPLICATIONS

This application is based upon and claims the benefit of priority from the corresponding Japanese Patent Application No. 2023-64321 filed on Apr. 11, 2023, the contents of which are hereby incorporated by reference.

### BACKGROUND OF THE INVENTION

### Field of the Invention

The present invention relates to an AI training method, an AI training device, and an AI training program.

### Description of Related Art

In conventional training of an AI (artificial intelligence) model by deep learning, creating a learning model with a certain level of recognition accuracy requires learning from a large number of sample data before training is complete, and thus the training requires a substantial amount of time. However, for example, with an AI model used for image recognition, even if its configuration is left substantially unchanged, some change in the configuration or the conditions such as hyperparameters necessitates retraining of the model from scratch using sample data.

By contrast, JP-A-2021-140400 discloses, as a method for creating an AI model using a trained AI model, a technique of, in training a training-target AI model, merging the weight coefficients of the layers constituting a neural network obtained from a plurality of trained AI models.

### SUMMARY OF THE INVENTION

With the known technology, it is possible to construct a common learning model that can be adapted to a plurality of environments by merging the weight coefficients of the layers constituting a neural network obtained from a plurality of trained AI models suitable for different environments. Inconveniently, however, because of the necessity for retraining of a new learning model, the training time is not necessarily expected to be improved.

In view of the above challenge, an object of the present invention is to provide a technology that can improve the training time in the training of an AI model.

According to an illustrative embodiment of the present invention, an AI training method that involves inputting training data to a training-target AI model including layers to generate a new trained AI model includes inputting training data to an existing trained AI model to acquire a trained-layer feature value output from a trained layer in the existing trained AI model, merging the trained-layer feature value with a training-target layer feature value output from a training-target layer in the training-target AI model to generate a merged feature value; and inputting the merged feature value to a training-target layer subsequent to the training-target layer to generate the new trained AI model.

### BRIEF DESCRIPTION OF THE DRAWINGS

FIG. 1 is a configuration diagram showing one example of an AI training device.

FIG. 2 is an illustrative diagram showing an outline of an AI training method.

FIG. 3 is an illustrative diagram showing one example of an AI training method using merging of trained-layer feature values in a trained AI model.

FIG. 4 is an illustrative diagram showing one example of the merging in FIG. 3.

FIG. 5 is a flow chart showing the AI training performed by a controller in the AI training device in FIG. 1.

### DETAILED DESCRIPTION OF PREFERRED EMBODIMENTS

Exemplary embodiments of the present invention will be described in detail below with reference to the accompanying drawings. It should be understood that the present invention is not limited to what is specifically described below.

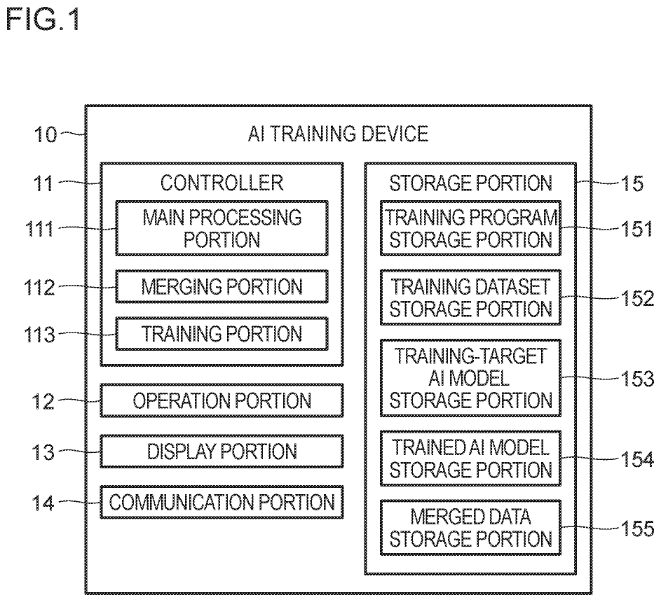

FIG. 1 is a configuration diagram showing one example of an AI training device 10. FIG. 1 shows components needed to describe the features of the embodiment; no description will be given of common components.

As shown in FIG. 1, the AI training device 10 includes a controller 11, an operation portion 12, a display portion 13, a communication portion 14, and a storage portion 15. The AI training device 10 is configured as what is called a computer device. The AI training device 10 performs training of an AI model.

The controller 11 is configured as a processor that performs computational processing and the like and controls various operations in the AI training device 10. The processor is configured to include, for example, a CPU (central processing unit). The controller 11 performs various kinds of processing in a neural network configured as an AI model.

The operation portion 12 is configured as an input device, such as a keyboard, that is operated by a user. The display portion 13 is configured as an output device such as a display. The display portion 13 is, for example, a liquid crystal display panel and may include an operation portion 12 of a touch panel type or the like. The display portion 13 displays various kinds of information related to the training of the AI model. The communication portion 14 is an interface for data communication with an external device via a communication network. The communication portion 14 is, for example, an NIC (network interface card).

The storage portion 15 is configured to include a volatile memory and a non-volatile memory and stores various kinds of information needed in the training of the AI model. The volatile memory is configured with, for example, a RAM (random-access memory). The non-volatile memory is configured with, for example, a ROM (read-only memory), a flash memory, or a hard disc drive. In the non-volatile memory, programs and data readable by the controller 11 are stored. A configuration is possible where at least part of the programs and data stored in the non-volatile memory are acquired from another computer device (server device) connected across a wire or wirelessly, or from a portable recording medium.

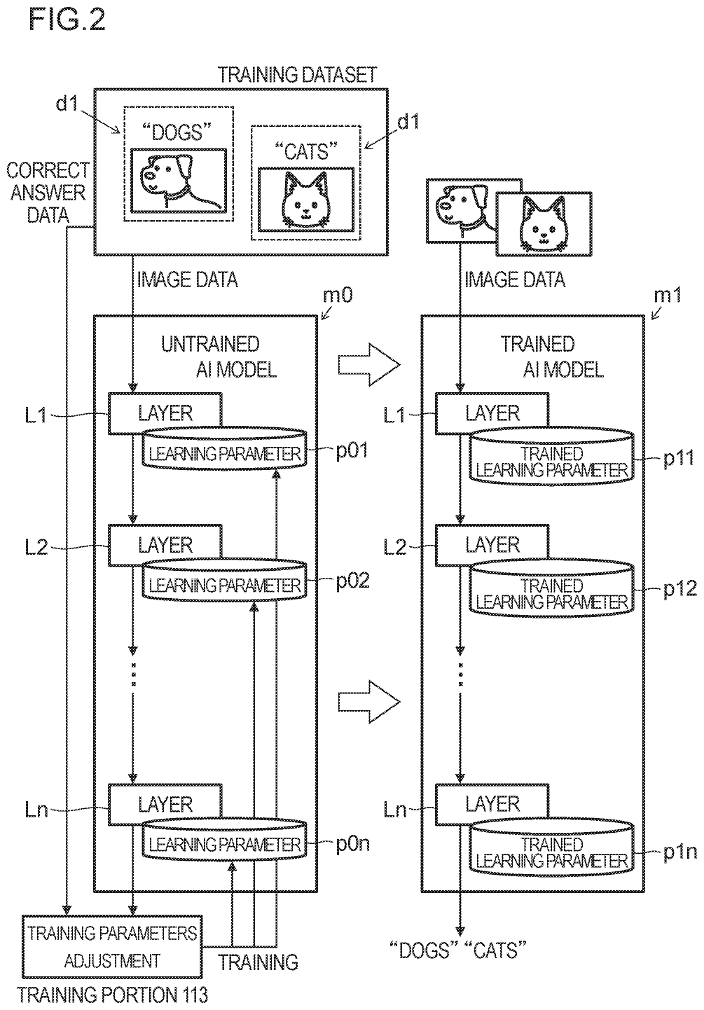

FIG. 2 is an illustrative diagram showing an outline of an AI training method. The AT training method shown in FIG. 2 is used to generate a trained AI model m1. The trained AT model m1 is generated by training an untrained AI model m0. The AI models m0 and m1 are, for example, image recognition AI models for image classification, object detection, or the like. However, the AI models m0 and m1 are not limited to image recognition AI models; they may be, for example, sound recognition AI models or the like.

The untrained AI model m0 and the trained AI model m1 each include a plurality of layers L1, L2, . . . , Ln that constitute a neural network. The layers L1, L2, . . . , Ln that constitute a neural network include, for example, a convolutional layer, a pooling layer, and the like. In the following description, the layers L1, L2, . . . , Ln may be referred to collectively as the “layers L”.

In the training of the untrained AI model m0, a training dataset is used which is a set of training data d1 containing image data or the like and teacher data containing correct answer labels. That is, the untrained AI model m0 is fed with the training data d1. In each layer L1, L2, . . . , the data input to it is subjected to computational processing with a learning parameter p01, p02, . . . , p0n such as a weight applied to it to extract (output) a feature value from the training data d1. The feature value is propagated (input) to the subsequent layer.

The output data from the layer Ln in the output stage (final stage) of the AI model m0 (that is, the inferred data provided by the AI model m0) is compared with the correct answer data in the training dataset. Then, the learning parameters p01, p02, . . . , p0n are adjusted so as to make the output data closer to the correct answer data. The training described above using the training data is repeated, and when the error between the output data of the AI model m0 and the correct answer data reaches a previously set predetermined learning threshold value, or when an epoch number, that is, the number of times that the training has been performed, reaches a previously set predetermined learning threshold number, the training is complete, yielding the trained AI model m1. The trained AI model m1 has trained learning parameters p11, p12, . . . , p1n for the layers L1, L2, . . . , Ln respectively.

In the AI training method of this embodiment, to reduce training time, training is performed while merging feature values obtained from a trained AI model. This AI training method continues to be described in detail.

As shown back in FIG. 1, the controller 11 includes, as its functions, a main processing portion 111, a merging portion 112, and a training portion 113. In this embodiment, the functions of the controller 11 are carried out by the processor performing computational processing according to a training program (an AI training program) stored in the storage portion 15.

The main processing portion 111 performs various kinds of computational processing in each layer in the neural network. In the computational processing, the main processing portion 111 performs operations by applying learning parameters such as weights to the data input to the layer. The computational processing in each layer can be performed by any known method.

The merging portion 112 acquires trained-layer feature values output from the trained layers in an existing trained AI model. Furthermore, the merging portion 112 performs merging to merge training-target layer feature values output from the training-target layers in a training-target AI model with the trained-layer feature values to generate merged feature values to be input to the subsequent training-target layers in the training-target AI model. Merging can be achieved, for example, by processing using a cross-attention mechanism, which will be described later, or by processing such as averaging or summing of feature values.

The training portion 113 performs training by adjusting the learning parameters, such as weights, that are used in the main processing portion 111 and in the merging portion 112. In other words, the training portion 113 minimizes the error between the output data of the AI model and the correct answer data in the training dataset, the latter being a set of teacher data, so as to bring the former closer to the optimal solution. This helps optimize the learning parameters in the AI model. Training using a training dataset can be performed by any known method such as a gradient descent method or an error back-propagation method.

The storage portion 15 includes a training program storage portion 151, a training dataset storage portion 152, a training-target AI model storage portion 153, a trained AI model storage portion 154, and a merged data storage portion 155.

The training program storage portion 151 stores the training program (AI training program) to be executed by the controller 11. The training program includes various programs for carrying out various functions of the AI training device 10. The training dataset storage portion 152 stores a training dataset which is a set of supervised training data used to train AI models. The supervised learning data is composed of input data (for example, image data) and correct answer data (for example, object names).

The training-target AI model storage portion 153 stores the training-target AI model to be trained by the training method of this embodiment along with the learning parameters for the training-target AI model. The trained AI model storage portion 154 stores the trained AI model used to train the training-target AI model along with the learning parameters for the trained AI model.

The merged data storage portion 155 stores various kinds of information related to the merging performed by the merging portion 112. For example, when a cross-attention mechanism is used in merging, the merged data storage portion 155 stores information related to the algorithm of the cross attention mechanism along with merging parameters for cross attention. Furthermore, the storage portion 15 includes data tables (not shown) for various kinds of processing.

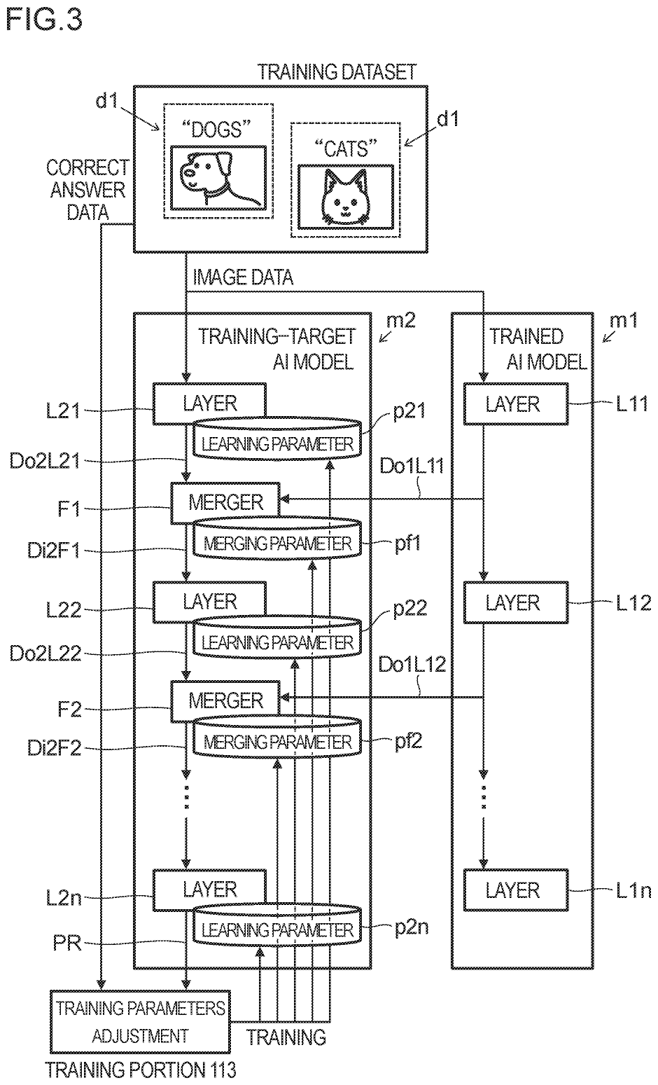

FIG. 3 is an illustrative diagram showing one example of an AI training method using merging of trained-layer feature values in the trained AI model m1. In the AI training method of this embodiment, a training-target AI model m2 and a trained AI model m1 are used. Before the training of the AI model, through operation by a trainer, the training-target AI model m2 is stored in the training-target AI model storage portion 153 in advance, and the trained AI model m1 is stored in the trained AI model storage portion 154 in advance.

The training-target AI model m2 and the trained AI model m1 have basically the same configuration. In this example, the training-target AI model m2 and the trained AI model m1 have a layer structure with the same number of (n) layers, the layers corresponding to each other between them (L21, L22, . . . , L2n and L11, L12, . . . , L1n respectively) having the same configuration. For example, if the training-target layer L21 in the training-target AI model m2 is a convolutional layer, also the trained layer L11 in the trained AI model m1 is a convolutional layer. To each of the training-target layers L21, L22, . . . , L2n in the training-target AI model m2, the learning parameters p21, p22, . . . , p2n are applied respectively.

The trained AI model m1 is a model with a function similar to that of the trained AI model targeted by the training-target AI model m2, and the closer the function is, the greater effect is expected. For example, if the training-target AI model m2 is one that recognizes “dogs”, it is expected that using as the trained AI model a trained AI model m1 that recognizes “animals” is likely to train the training-target AI model m2 more efficiently than using a trained AI model m1 that recognizes “vehicles”.

This training utilizes the correlation between the output of the training-target layers in the training-target AI model m2 in a trained state and the output of the trained layers in the trained AI model m1. Thus, if a correlation is present there, the training is expected to give an effect, and the higher the correlation, the higher effect is expected. Thus, preferred as the trained AI model m1 is a model that has a similar function to the trained AI model targeted by the training-target AI model m2 and that has a similar model structure (layer connection structure, layer types, and the like) to it.

Attempts are often made to improve the structure of an AI model to enhance its performance and function. In such cases, the training-target AI model m2 is often improved based on the trained AI model m1. One example is a case where the training-target AI model m2 has the same layer connection structure as the trained AI model m1 and a convolutional layer used in the training-target layer L21 in the training-target AI model m2 is a modified version of a convolutional layer used in the trained layer L11 in the trained AI model m1. In such a case, high similarity between the training-target AI model m2 and the trained AI model m1 is expected to give a great effect of improving learning efficiency.

During training, the training-target AI model m2 is configured such that mergers F1 to F−1 (not shown) are inserted between the training-target layers (L21 to L2n). The mergers F1 to Fn−1 respectively hold (store) data of parameters pf1 to pfn−1 (not shown) that determine the operational characteristics of merging. The mergers F1 to Fn−1 and the learning parameters pf1 to pfn−1 are deleted from the training-target AI model m2 on completion of training.

The mergers F1 to Fn−1 receive training-target layer feature values Do2L21 to Do2L2n−1 that are output respectively from the training-target layers (L21 to L2n) in the training-target AI model m2. The mergers F1 to Fn−1 also receive trained-layer feature values Do1L11 to Do1L1n−1 that are output respectively from the trained layers (L11 to L1n) in the training-target AI model m1. The mergers F1 to Fn−1 merge together the training-target layer feature values Do2L21 to Do2L2n−1 and the trained-layer feature values Do1L11 to Do1L1n−1 output respectively from the training-target layers (L21 to L2n) and the trained layers (L11 to L1n) corresponding to each other between the training-target AI model m2 and the trained AI model m1. Then, the mergers F1 to Fn−1 feed the merged feature values Di2F1 to Di2Fn−1 respectively to the subsequent training-target layers (L22 to L2n) in the training-target AI model m2.

The merging performed by the mergers F1 to Fn−1 can be achieved by any of various processing based on the received feature values, such as averaging (Di2F1=(Do2L21+Do1L11)/2).

By setting and adjusting the values of the merging parameters pf1 to pfn−1, the mergers F1 to Fn−1 can adjust the degree of merging of the trained-layer feature values Do1L11 to Do1L1n−1 from the trained AI model m1. For example, by using a degree of merging as the merging parameter pf1, it is possible to obtain, as the merged feature value output from the merger F1, Di2F1=Do2L21×(pfn−1)+Do1L11×pf1. In this case, giving the merging parameters pf1 to pfn−1 increasingly small values as training progresses helps reduce the influence of the trained-layer feature values Do1L11 to Do1L1n−1 from the trained AI model m1, and this helps suppress excessive influence from the trained AI model m1 at the stage of the end of the training.

The progress of training can be represented by a “training progress index”, which is a value that indicates how far training has progressed since the start of the training of the training-target model. Specifically, the training progress index can be determined based on the number of times that the training has been performed, the error of the output data of the training-target model from the correct answer data, and the like.

The training portion 113 receives the output of the training-target AI model m2 (the output from the final training-target layer L2n) and the correct answer data in the training data and, based on the difference between the two, adjusts the learning parameters p21 to p2n for the training-target layers L21 to L2n respectively. The adjustment of the learning parameters can be performed by a training method such as a gradient descent method or an error back-propagation method.

Processing in the training-target layers L21 to L2n in the training-target AI model m2 and the trained layers L11 to L1n in the trained AI model m1 is handled by the main processing portion 111. The merging in the mergers F1 to Fn−1 is handled by the merging portion 112. Adjustment of the learning parameters is handled by the training portion 113.

Next, the operation, state transitions, and the like during training will be explained sequentially. The operation is carried out by the controller 11 in the AI training device 10.

During training, the controller 11 inputs the same training data d1 from the same training dataset to both the training-target AI model m2 and the trained AI model m1 simultaneously.

The training-target layer L21 in the training-target AI model m2 processes the received training data d1 based on the currently trained learning parameter p21 to generate the training-target layer feature value Do2L21, and outputs it to the merger F1. On the other hand, the trained layer L11 in the trained AI model m1 processes the received training data d1 based on the trained learning parameter to generate the trained-layer feature value Do1L11, and outputs it to the merger F1 and to the trained layer L12. Then, the merger F1 merges the received training-target layer feature value Do2L21 with the received trained-layer feature value Do1L11 using the merging parameters pf1 to generate the merged feature value Di2F1, and feeds it to the layer L22.

Next, the training-target layer L22 in the training-target AI model m2 processes the received merged feature value Di2F1 based on the currently trained learning parameter p22 to generate the training-target layer feature value Do2L22, and outputs it to the merger F2. On the other hand, the trained layer L12 in the trained AI model m1 processes the received trained-layer feature value Do1L11 based on the trained learning parameter to generate the trained-layer feature value Do1L12, and outputs it to the merger F2 and to the trained layer L13. Then, the merger F2 merges the received training-target layer feature value Do2L22 with the received trained-layer feature value Do1L12 using the merging parameters pf2 to generate the merged feature value Di2F2, and feeds it to the layer L23 (not shown).

Thereafter, processing similar to what has been described above is performed by the training-target layers L23 to L2n−1 in the training-target AI model m2, the trained layers L13 to L1n−1 in the trained AI model m1, and the mergers F3 (not shown) to Fn−1. Then, the training-target layer L2n in the training-target AI model m2 processes the merged feature value Di2F1n−1 fed from the merger Fn−1 based on the currently trained learning parameter p2n to generate and output an inferred value PR, which is the output data of the training-target AI model m2. Then, the controller 11 in the AI training device 10 compares the correct answer data in the training data with the inferred value PR, which is the output of the training-target AI model m2 and, based on their difference, modifies the learning parameters p21 to p2n in the training-target layers L21 to L2n. Then, the training data in the training dataset is sequentially fed to the training-target AI model m2 and to the trained AI model m1, and in this way training is achieved through the processing described above.

Through the merging by the merging portion 112, relevant information in the trained AI model m1 is transferred to the training-target AI model m2. For example, at an early stage of training, the learning parameters in the layers are data that is far from adequate values. Thus, before the preceding layers are sufficiently trained (before their learning parameters are sufficiently optimized), the subsequent layers are likely to be fed with inappropriate data. However, in this embodiment, by merging the outputs of the trained layers in the trained AI model m1, that is, data that is likely to have been already optimized, it is possible to use, as the input data to the training-target layers in the training-target AI model m2, reasonably appropriate data at an early stage of training.

This results in a high reduction rate of the error of the training-target AI model m2 from the correct answer data compared to in a case where training is continued without merging. This helps reduce the time taken by the training-target AI model m2 to come close to correct answer data, and helps reduce the time required to complete training.

The controller 11 changes the degree of merging based on the training progress index of the training-target AI model m2. For example, the controller 11 reduces the degree of merging based on the number of times that the training has been performed on the training-target AI model m2 and its error from the correct answer data. That is, the controller 11 reduces the influence of the trained-layer feature values Do1L11 to Do1L1n−1 output from the trained layers (L11 to L1n) in the trained AI model m1 on the training-target layer feature values Do2L21 to Do2L2n−1 output from the training-target layers (L21 to L2n) in the training-target AI model m2.

This helps suppress an excessive influence of merging at an advanced stage of training. At an advanced stage of training, the output data of the training-target layers in the training-target AI model m2 has undergone substantial optimization. Thus, the training of the subsequent layers can progress efficiently, and reducing the degree of merging causes only a minimal drop in efficiency.

While, in the embodiment shown in FIG. 3, a merger F is provided between every two layers L, it may be provided between not all but some of the layers. For example, while the merger F1 is provided, the merger F2 can be omitted, in which case the training-target layer feature value Do2L22 output from the training-target layer L22 can be fed to the training-target layer L23.

The trained AI model m1 does not necessarily have to have the same configuration as the training-target AI model m2. For example, they may have different numbers of layers. However, the trained layers in the trained AI model m1 and the training-target layers in the training-target AI model m2 that are to be merged together need to be, with consideration given to the overall structure of those learning models, appropriately configured so that the output data is similar between them. Here, it is necessary to keep the same upstream/downstream relationships between among the trained layers in the trained AI model m1 and among the training-target layers in the training-target AI model m2. For example, it is necessary to avoid merging the training-target layer feature value output from the training-target layer L21 in the training-target AI model m2 with the trained-layer feature value output from an trained layer L14 (not shown) in the trained AI model m1, or merging the training-target layer feature value output from the training-target layer L23 in the training-target AI model m2 with the trained-layer feature value output from the trained layer L12 in the trained AI model m1.

With the configuration described above, through training using the trained-layer feature values output from the trained layers in the trained AI model m1, improved learning accuracy is expected especially at an early stage of training, achieving improved learning efficiency of the training-target AI model m2 and reduced training time. Based on the training progress index of the training-target AI model m2, the degree of merging of the trained-layer feature values output from the trained layers in the trained AI model m1 with the training-target layer feature values output from the training-target layers in the training-target AI model m2 is changed. That is, it is possible to reduce merging before the completion of training. This helps suppress an excessive influence of merging at an advanced stage of training. Thus, it is possible to train the training-target AI model m2 efficiently.

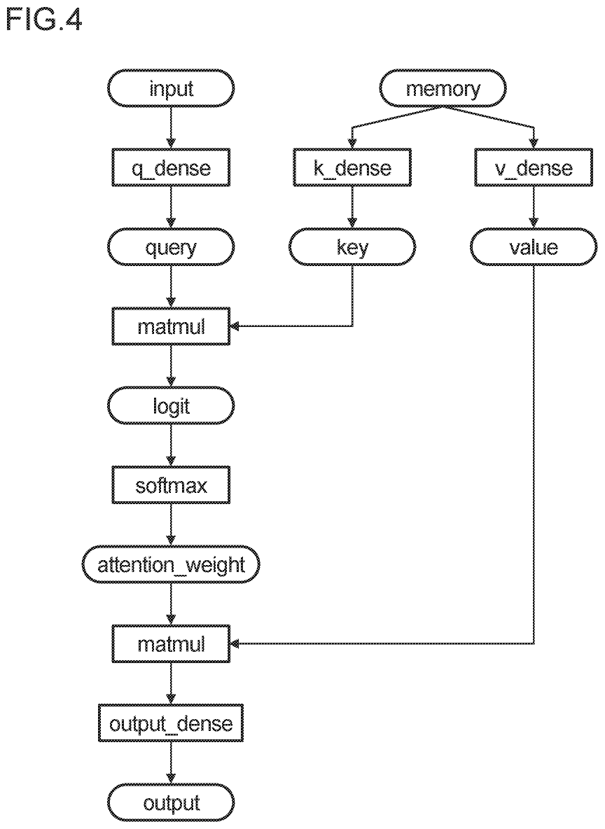

FIG. 4 is an illustrative diagram showing one example of the merging in FIG. 3. In the merging, the merging portion 112 (controller 11) merges a training-target layer feature value Do2L2x (where x is a variable representing the layer number, x=1 to n−1) with a trained-layer feature value Do1L1x using, for example, a cross-attention mechanism as shown in FIG. 4.

In FIG. 4, the “input” is the training-target layer feature value Do2L2x, which is the output of the pre-merging training-target layer L2x (where x is a variable representing the layer number, x=1 to n−1) in the training-target AI model m2. The “memory” is the trained-layer feature value Do1L1x, which is the output of the trained layer L1x in the trained AI model m1 corresponding to the pre-merging training-target layer L2x in the training-target AI model m2.

The input, which is the training-target layer feature value Do2L2x, is converted into a “query” in a dense layer. The memory, which is the trained-layer feature value Do1L1x, is converted into a “key” and a “value” in dense layers. With respect to the feature value, the query is a search target, the key is a search word, and the value is search source data. In the attention mechanism, with respect to the feature value, information is extracted from the memory (the key as a search word and the value as search source data) according to the query (search target).

The inner product (“logit”) of the query and the key is calculated in a first matmul layer to yield their similarity. The inner product (logit) of the query and the key is, for subsequent processing, subjected to Softmax processing to be normalized. Thus, normalization is performed so that the sum of weights for each query is 1.0, and thereby an “attention_weight” is yielded. Then, in a matmul layer, the inner product of the attention_weight and the value is calculated, and information as to the value is extracted according to the weight.

In this way, in the merging, information in the “memory” is reflected in the “input”, and an “output” is yielded. The “output” is the merged feature value Di2Fx, which is to be input to the subsequent training-target layer L2x+1 in the training-target AI model m2.

As described above, in the merging, the input, which is the training-target layer feature value Do2L2x, is converted with reference to the memory value, which is the trained-layer feature value Do1L1x, and is then output (the output). More specifically, the input, which is the training-target layer feature value Do2L2x is, by extraction of a region of it close to the memory value, which is the trained-layer feature value Do1L1x, converted so as to be influenced strongly by the memory value. That is, the information held by the memory, which is the trained-layer feature value Do1L1x, is increasingly reflected in the input, which is the training-target layer feature value Do2L2x. Since the input, which is the training-target layer feature value Do2L2x, is converted with reference to the memory value, which is the trained-layer feature value Do1L1x, it is converted to be closer to the memory value.

When changing the degree of merging in merging, reducing the “value” (weakening the degree) results in reducing the influence of the trained-layer feature value Do1L1x on the training-target layer feature value Do2L2x.

As described above, in merging, by using the cross-attention mechanism, it is possible to automatically identify what region to focus on with respect to a feature value in learning. For example, in image recognition, it is possible to focus on, of the foreground and background of an image, the foreground as the target for recognition and perform learning specialized for the foreground to be focused on. That is, by suppressing the influence of the background that is irrelevant to recognition and specializing for the foreground to be focused on, it is possible to efficiently extract the feature value.

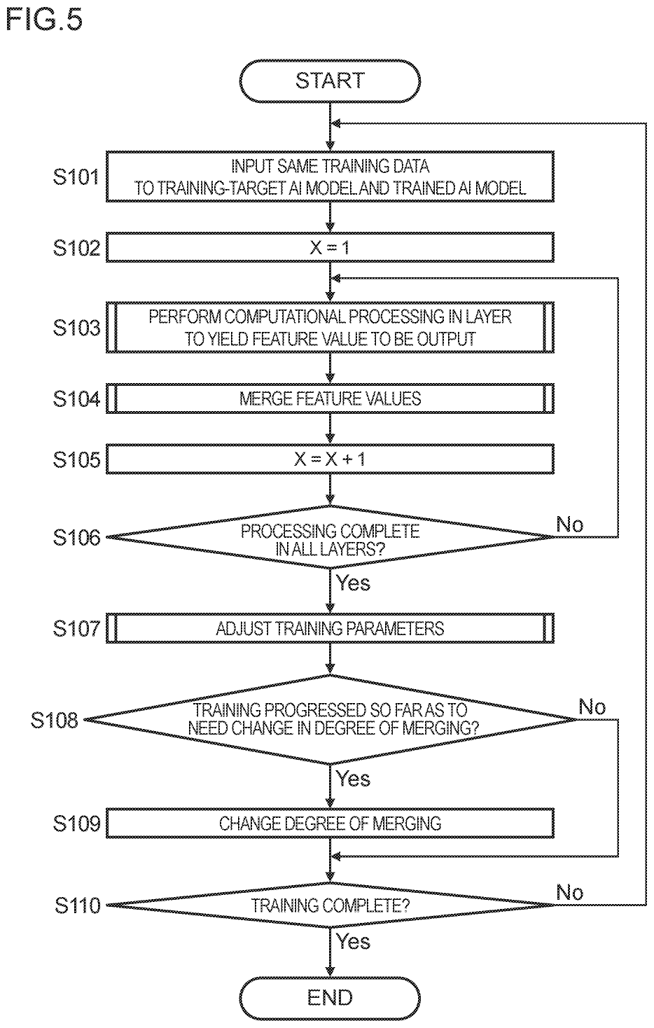

FIG. 5 is a flow chart showing the AI training performed by the controller 11 in the AI training device 10. This flowchart illustrates the technical features involved in a computer program that enables a computer device to perform training of an AI model. The computer program can be stored and provided (sold, distributed, etc.) on any of various readable non-volatile recording media. The computer program may include a single program, or may include multiple programs that run in coordination.

The procedure shown in FIG. 5 is executed when a designer or the like of the AI training device 10 trains the target AI model m2 stored in the storage portion 15. For example, it is executed when a training starting operation is performed on the operation portion 12 such as a keyboard. The procedure will now be described with reference, as necessary, to FIG. 3.

In step S101, the controller 11 inputs the same training data d1 from the same training dataset to both the training-target AI model m2 and the trained AI model m1, as input data to the training-target layer L21 in the training-target AI model m2 and to the trained layer L11 in the trained AI model, and the procedure proceeds to step S102.

In step S102, the controller 11 sets the variable x representing the layer number to one, and the procedure proceeds to step S103.

In step S103, the controller 11 performs, with respect to the input data to the training-target layer L2x in the training-target AI model m2 and to the trained layer L1x in the trained AI model m1, various kinds of computational processing in each layer to yield output data (the training-target layer feature value Do2L2x and the trained-layer feature value Do1L1x), and the procedure proceeds to step S104.

In Step S104, the controller 11 merges the training-target layer feature value Do2L2x, which is the output data from the training-target layer L2x in the training-target AI model m2, and the trained-layer feature value Do1L1x, which is the output data from the layer L1x in the trained AI model m1, to yield the merged feature value Di2Fx as input data to the subsequent training-target layer L2x+1 in the training-target AI model m2, and the procedure proceeds to step S105. When the variable x indicating the layer number equals n, no merging in step S104 needs to be performed.

In step S105, the controller 11 increments the variable x representing the layer number by one, and the procedure proceeds to step S106.

In step S106, the controller 11 judges whether computational processing is complete for all the training-target layers L2x (L21 to L2n) in the training-target AI model m2 (complete if x=n) and, if so, the procedure proceeds to step S107; otherwise it returns to step S103.

In step S107, the controller (training portion 113) adjusts the learning parameters based on the error between the inferred value PR, which is the output data from the training-target AI model m2 (the layer L2n), and the correct answer data of the training data using, for example, a gradient descent method or a back-propagation method, and the procedure proceeds to step S108.

In step S108, the controller 11 judges whether the training has progressed so far as to need a change in the degree of merging. Specifically, the controller 11 judges whether the number of times that the training has been performed has reached a previously set predetermined number, or whether the error between the output data of the training-target AI model m2 and the correct answer data has reached a previously set predetermined progress index threshold value and, if so, the procedure proceeds to step S109; otherwise it proceeds to step S110. For the predetermined number of times that the training has been performed and the predetermined progress index threshold value, it is possible to use values set by a developer of the AI model or the like through, for example, experiments.

In step S109, the controller 11 changes the degree of merging in merging, and the procedure proceeds to step S110. For the value for the degree of merging in accordance with the training progress index, it is possible to use a value set by the developer of the AI model or the like through, for example, experiments.

In step S110, the controller 11 judges whether the training of the training-target AI model m2 is complete and, if so, the procedure according to the flow chart ends; otherwise it returns to step S101.

Here, the controller 11 judges whether the training of the training-target AI model m2 is complete based on whether the error between the output data of the training-target AI model m2 and the correct answer data has reached a predetermined value or whether the epoch number, that is, the number of times that the training has been performed, has reached a predetermined value.

In merging, the degree of merging may be gradually reduced as the number of times that the training has been performed on the training-target AI model m2 increases. With this configuration, in the training of the training-target AI model m2, it is possible to gradually reduce (weaken) the influence of the trained-layer feature values in the trained AI model m1. It is thus possible to control the balance between training efficiency and excessive influence of merging in accordance with training progress.

A configuration is also possible where merging is terminated before the completion of the training of the training-target AI model m2. With this configuration, merging ceases to be performed in the course of the training of the target AI model m2, and this is expected to save time according to the duration of merging.

### <Notes>

The various technical features disclosed herein as embodiments may allow for many modifications without departing from the spirit of the present invention. That is, the embodiments described above should be considered to be illustrative in all respects and should not be considered to be restrictive. The scope of the present invention is defined not by the description of the embodiments given above but by the appended claims, and should be understood to encompass any modifications made in the sense and scope equivalent to those of the claims. The different embodiments disclosed herein can be implemented in any feasible combination.

While, in the above embodiment, various functions are carried out on a software basis through computational processing by the CPU according to the program, one or more of these functions may be achieved by an electrical hardware resource. The hardware resource can be, for example, an ASIC (application-specific integrated circuit) or an FPGA (field-programmable gate array). Conversely, one or more of the functions achieved by a hardware resource may be achieved on a software basis.

The scope of the embodiments encompasses a computer program that enables a processor (computer) to carry out one or more of the functions of the AI training device 10. The scope of the embodiments also encompasses a computer-readable non-volatile recording medium that stores such a computer program. The non-volatile storage medium may be, for example, other than the non-volatile memory described above, an optical recording medium (such as an optical disc), a magneto-optical recording medium (such as a magneto-optical disc), a USB memory, an SD card, and the like.

What is claimed is:

1. An AI training method involving inputting training data to a training-target AI model including layers to generate a new trained AI model, the method comprising:
inputting the training data to an existing trained AI model to acquire a trained-layer feature value output from a trained layer in the existing trained AI model,
merging the trained-layer feature value with a training-target layer feature value output from a training-target layer in the training-target AI model to generate a merged feature value, and
inputting the merged feature value to a training-target layer subsequent to the training-target layer to generate the new trained AI model.

2. The AI training method according to claim 1, further comprising:
in generating the merged feature value, merging the trained-layer feature value with the training-target layer feature value using a cross-attention mechanism.

3. The AI training method according to claim 2, further comprising:
reducing a degree of merging as training progresses.

4. The AI training method according to claim 1, further comprising:
terminating generation of the merged feature value when a training progress index has reached a prescribed progress index threshold value.

5. The AI training method according to claim 1,
wherein
the training-target AI model and the existing trained AI model have a layer structure with a same number of layers, each pair of layers corresponding to each other between the training-target AI model and the existing trained AI model having a same configuration, and
the training-target layer feature value and the trained-layer feature value respectively output from a training-target layer and a trained layer corresponding to each other between the training-target AI model and the existing trained AI model are merged together.

6. An AI training device in which training data is input to a training-target AI model including layers to generate a new trained AI model,
wherein,
the training data is input to an existing trained AI model to acquire a trained-layer feature value output from a trained layer in the existing trained AI model,
the trained-layer feature value is merged with a training-target layer feature value output from a training-target layer in the training-target AI model to generate a merged feature value, and
the merged feature value is input to a training-target layer subsequent to the training-target layer to generate the new trained AI model.

7. The AI training device according to claim 6,
wherein
in generating the merged feature value, the trained-layer feature value is merged with the training-target layer feature value using a cross-attention mechanism.

8. The AI training device according to claim 7,
wherein
a degree of merging is reduced as training progresses.

9. The AI training device according to claim 6,
wherein
generation of the merged feature value is terminated when a training progress index reaches a prescribed progress index threshold value.

10. The AI training device according to claim 6,
wherein
the training-target AI model and the existing trained AI model have a layer structure with a same number of layers, each pair of layers corresponding to each other between the training-target AI model and the existing trained AI model having a same configuration, and
the training-target layer feature value and the trained-layer feature value respectively output from a training-target layer and a trained layer corresponding to each other between the training-target AI model and the existing trained AI model are merged together.

11. An AI training program involving inputting training data to a training-target AI model including layers to generate a new trained AI model, the program making a computer perform a procedure comprising:
inputting the training data to an existing trained AI model to acquire a trained-layer feature value output from a trained layer in the existing trained AI model;
merging the trained-layer feature value with a training-target layer feature value output from a training-target layer in the training-target AI model to generate a merged feature value; and
inputting the merged feature value to a training-target layer subsequent to the training-target layer to generate the new trained AI model.
